(19) United States
(12) Patent Application Publication
(10) Pub. No.: US 2016/0371624 A1
(43) Pub. Date: Dec. 22, 2016

(54) Quality Control Checklist Systems and Methods

(71) Applicant: Caterpillar Inc., Peoria, IL (US)

(72) Inventor: Otto Breitschwerdt, Apex, NC (US)

(73) Assignee: Caterpillar Inc., Peoria, IL (US)

(21) Appl. No.: 14/744,149

(22) Filed: Jun. 19, 2015

(51) Int. Cl. G06Q 10/06

(52) U.S. Cl. CPC G06Q 10/06395

(57) ABSTRACT

Methods and systems for controlling quality of a finished part use a quality control server associated with a checklist database. A quality control checklist is written to the checklist database and includes a plurality of inspection items, each inspection item identifying a specification characteristic associated with the finished part. A portable electronic device may receive the checklist and transmit an administration or auditing instruction associated with at least one inspection item. An updated or completed quality control checklist is generated based on the administration or auditing instruction, and the updated quality control checklist is stored in the checklist database.

### TECHNICAL FIELD

The present disclosure generally relates to creating, modifying, and accessing quality control checklists using a portable electronic device.

### BACKGROUND

Quality control checklists are generally known and used to ensure that finished parts provided by a supplier are free of defects and therefore acceptable to the recipient. Such checklists typically include a series of inspection items to be performed on the finished part. While many inspection items are objectively clear as to the basis and method for determining whether a defect exists, some inspection items may be more subjective and open to interpretation, causing inconsistent criteria to be applied and increasing the likelihood of parts with defects being shipped from the supplier to the recipient. Additionally, quality control checklists may be configured in a manner that is inconvenient or inefficient to perform, causing further delay and waste.

### SUMMARY OF THE DISCLOSURE

In accordance with another aspect of the present disclosure, which may be combined with any of these aspects, a method is provided of controlling quality of a finished part using a quality control server associated with a checklist database. The method includes storing a quality control checklist in the checklist database, the quality control checklist including a plurality of inspection items, each inspection item identifying a specification characteristic associated with the finished part. The quality control checklist is transmitted to a portable electronic device, and an auditing result indicating an inspection status associated with at least one inspection item of the plurality of inspection items is received from the portable electronic device. A completed quality control checklist is generated based on the auditing result, the completed quality control checklist including the inspection status associated with the at least one inspection item, and the completed quality control checklist is stored in the checklist database.

In accordance with another aspect of the present disclosure, which may be combined with any of these aspects, a system of controlling quality of a finished part includes a checklist database and a quality control server linked to the checklist database. The quality control server includes a processor configured via computer-executable instructions to store a quality control checklist in the checklist database, the quality control checklist including a plurality of inspection items, each inspection item identifying a specification characteristic associated with the finished part, transmit the quality control checklist to a portable electronic device, receive, from the portable electronic device, an auditing result indicating an inspection status associated with at least one inspection item of the plurality of inspection items, generate a completed quality control checklist based on the auditing result, the completed quality control checklist including the inspection status associated with the at least one inspection item, and store the completed quality control checklist in the checklist database.

In accordance with one aspect of the present disclosure, which may be combined with any of these aspects, a method is provided of controlling quality of a finished part using a quality control server associated with a checklist database. The method includes writing a quality control checklist to the checklist database, the quality control checklist including a plurality of inspection items ordered in an initial sequence, each inspection item identifying a specification characteristic associated with the finished part. The quality control checklist is transmitted to a portable electronic device and an administration instruction for modifying at least one inspection item of the plurality of inspection items is received from the portable electronic device. An updated quality control checklist is generated based on the administration instruction for modifying the at least one inspection item, and the updated quality control checklist is stored in the checklist database.

In accordance with another aspect of the present disclosure, which may be combined with any of these aspects, the inspection status comprises a passing status or a failing status.

In accordance with another aspect of the present disclosure, which may be combined with any of these aspects, an inspection note associated with the auditing result may be received from the portable electronic device.

In accordance with another aspect of the present disclosure, which may be combined with any of these aspects, the inspection note is provided in at least one of a text format, a photo format, a video format, or an audio format.

In accordance with another aspect of the present disclosure, which may be combined with any of these aspects, the completed quality control checklist includes an inspection status identifier column, and in which the inspection note is stored in the inspection status identifier column.

In accordance with another aspect of the present disclosure, which may be combined with any of these aspects, the completed quality control checklist includes a notes column, and in which the inspection note is stored in the notes column.

In accordance with another aspect of the present disclosure, which may be combined with any of these aspects, the completed quality control checklist may be transmitted to a second portable electronic device.

In accordance with another aspect of the present disclosure, which may be combined with any of these aspects, the administration instruction includes an annotation associated with at least one of the plurality of inspection items, and in which the annotation is stored with the updated quality control checklist in the checklist database.

In accordance with another aspect of the present disclosure, which may be combined with any of these aspects, the annotation is provided in at least one of a text format, a photo format, a video format, or an audio format.

In accordance with another aspect of the present disclosure, which may be combined with any of these aspects, the administration instruction includes a revised inspection item, and in which the updated quality control checklist includes the revised inspection item.

In accordance with another aspect of the present disclosure, which may be combined with any of these aspects, the administration instruction includes a request to delete a selected one of the plurality of inspection items, and in which the updated quality control checklist is modified to remove the selected one of the plurality of inspection items from the quality control checklist.

In accordance with another aspect of the present disclosure, which may be combined with any of these aspects, the administration instruction includes a reordered sequence of the plurality of inspection items, and the updated quality control checklist includes the plurality of inspection items ordered in the reordered sequence.

### BRIEF DESCRIPTION OF THE DRAWINGS

FIG. 1 is a simplified schematic view of a checklist management system according to certain embodiments of the present disclosure.

FIG. 2 is an exemplary architectural diagram corresponding to the checklist management system of FIG. 1.

FIG. 3 is a schematic view of an illustrative electronic device for providing an application operative to interface with a checklist database according to certain embodiments of the present disclosure.

FIG. 4 is schematic view of a checklist access interface available to a user of the electronic device of FIG. 3 in accordance with an embodiment of the disclosed principles.

FIG. 5 is a schematic view of a checklist editing interface available to a user of the electronic device of FIG. 3 in accordance with an embodiment of the disclosed principles.

FIG. 6 is a schematic view of a checklist auditing interface available to a user of the electronic device of FIG. 3 in accordance with an embodiment of the disclosed principles.

FIG. 7 is a schematic view of an example transaction series for editing a quality control checklist using the checklist management system of FIG. 1.

FIG. 8 is a schematic view of an example transaction series for adding an audit note to a quality control checklist using the checklist management system of FIG. 1.

FIG. 9 is a flow chart showing an illustrative process of controlling quality of a finished part by permitting editing of a quality control checklist.

FIG. 10 is a flow chart showing an illustrative process of controlling quality of a finished part by permitting annotations to be added to a checklist during auditing.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

Checklist management systems and methods are disclosed herein for controlling quality of one or more finished parts provided by a supplier to a recipient. The finished part may be an individual component, sub-assembly of components, or full assembly of components. To ensure that the finished part is free of defects, the checklist management system may be used to develop a quality control checklist that may be transmitted, updated, and implemented in a quality control audit process. In the embodiments disclosed herein, the supplier maintains the quality control checklist, however the quality control checklist may additionally or alternatively be maintained by the recipient or jointly by the supplier and the recipient.

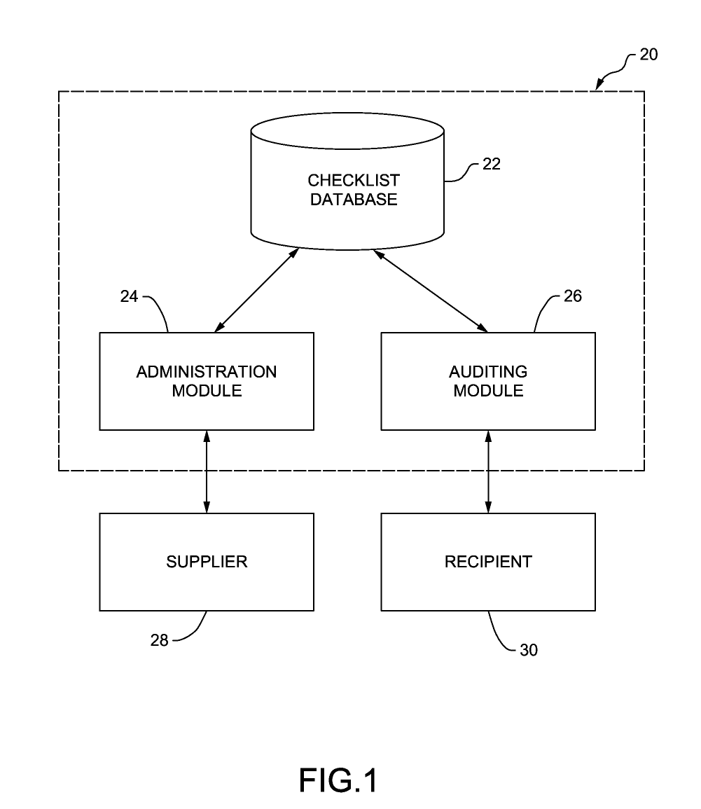

FIG. 1 provides a schematic representation of a checklist management system 20 according to certain embodiments of the present disclosure. In the illustrated embodiment, the checklist management system 20 includes a checklist database 22 coupled to an administration module 24 and an auditing module 26. The administration module 24 may be configured to handle administrative functions related to the checklist management system 20, such as system access and permissions, creating/modifying/deleting (archiving) checklists, adding supplier information, adding auditor information, adding supplier codes (to identify the source of the finished part), configuring systems, reporting, and receiving recipient-proposed changes.

The auditing module 26 may be configured to handle use of a checklist in a quality control audit process, including providing access to the checklists, permitting entry of auditing results, entering notations, and reporting functions. Alternatively, a single module (not shown) may be used to handle both the administrative and auditing functions of the checklist management system 20. A supplier 28 and a recipient 30 communicate with the checklist management system 20, as well as between each other. The supplier 28 may manufacture a finished part and the recipient 30 may receive the part. The supplier 28, recipient 30, or both supplier 28 and recipient 30 may use the quality control checklist during inspection of the finished part.

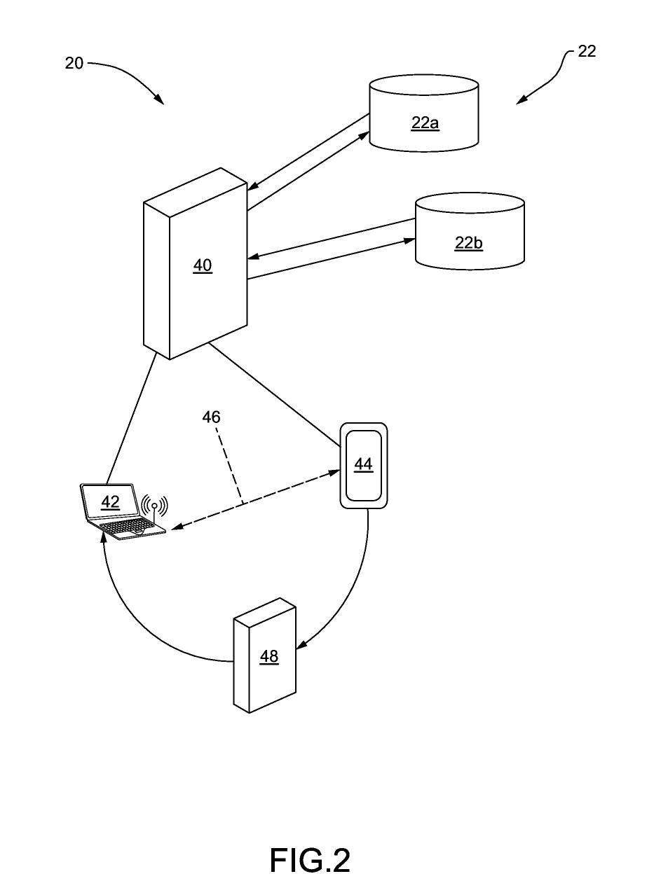

An exemplary architectural layout of the checklist management system 20 is illustrated at FIG. 2. In this embodiment, a server 40 is coupled to the checklist database 22, which may include a first checklist database 22a, and a second checklist database 22b. The server 40 further may be coupled to a checklist generator 42 which may provide inputs to create and store quality control checklists in the checklist database 22 using the administration module 24. A device 44, which in the exemplary embodiment is a handheld, remote device, may selectively communicate with the server 40 to access, modify, and/or use quality control checklists stored in the checklist database 22. The device 44 further may communicate with the checklist generator 42, such as through a direct communication link 46, the server 40, or an email server 48.

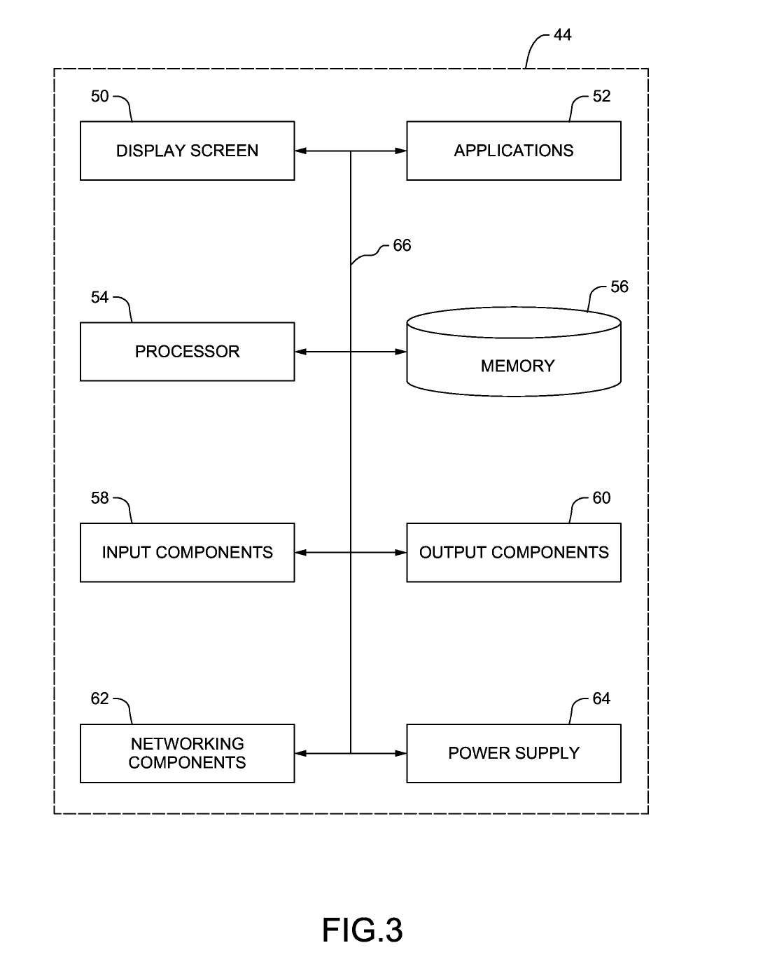

Components of the device 44 are schematically illustrated in FIG. 3. In the exemplary embodiment, the device 44 includes a display screen 50, applications (e.g., programs) 52, a processor 54, a memory 56, one or more input components 58 such as speech and text input facilities, and one or more output components 60 such as text and audible output facilities, e.g., one or more speakers. The processor 54 may be any of a microprocessor, microcomputer, application-specific integrated circuit, or the like. For example, the processor 54 can be implemented by one or more microprocessors or controllers from any desired family or manufacturer.

Similarly, the memory 56 may reside on the same integrated circuit as the processor 54. Additionally or alternatively, the memory 56 may be accessed via a network, e.g., via cloud-based storage. The memory 56 may include a random access memory (i.e., Synchronous Dynamic Random Access Memory (SDRAM), Dynamic Random Access Memory (DRAM), RAMBUS Dynamic Random Access Memory (RDRM) or any other type of random access memory device). Additionally or alternatively, the memory 56 may include a read only memory (i.e., a hard drive, flash memory or any other desired type of memory device).

The information that is stored by the memory 56 can include program code associated with one or more operating systems or applications as well as informational data, e.g., program parameters, process data, etc. The operating system and applications are typically implemented via executable instructions stored in a non-transitory computer readable medium (e.g., memory 56) to control basic functions of the electronic device. Such functions may include, for example, interaction among various internal components and storage and retrieval of applications and data to and from the memory 56.

Further with respect to the applications 52, these typically utilize the operating system to provide more specific functionality, such as file system service and handling of protected and unprotected data stored in the memory 56. Although many applications provide standard or required functionality of the user device 44, some applications may provide optional or specialized functionality, and may be supplied by third party vendors or the device manufacturer.

Finally, with respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

The device 44 having the illustrated component group may include software and hardware networking components 62 to allow communications to and from the device. Such networking components 62 will typically provide wireless networking functionality, although wired networking may additionally or alternatively be supported.

In an embodiment, a power supply 64, such as a battery or fuel cell, may be included for providing power to the device 44 and its components. All or some of the internal components communicate with one another by way of one or more shared or dedicated internal communication links 66, such as an internal bus.

In an embodiment, the device 44 is programmed such that the processor 54 and memory 56 interact with the other components of the device 44 to perform certain functions. The processor 54 may include or implement various modules and execute programs for initiating different activities such as launching an application, transferring data, and toggling through various graphical user interface objects (e.g., toggling through various display icons that are linked to executable applications).

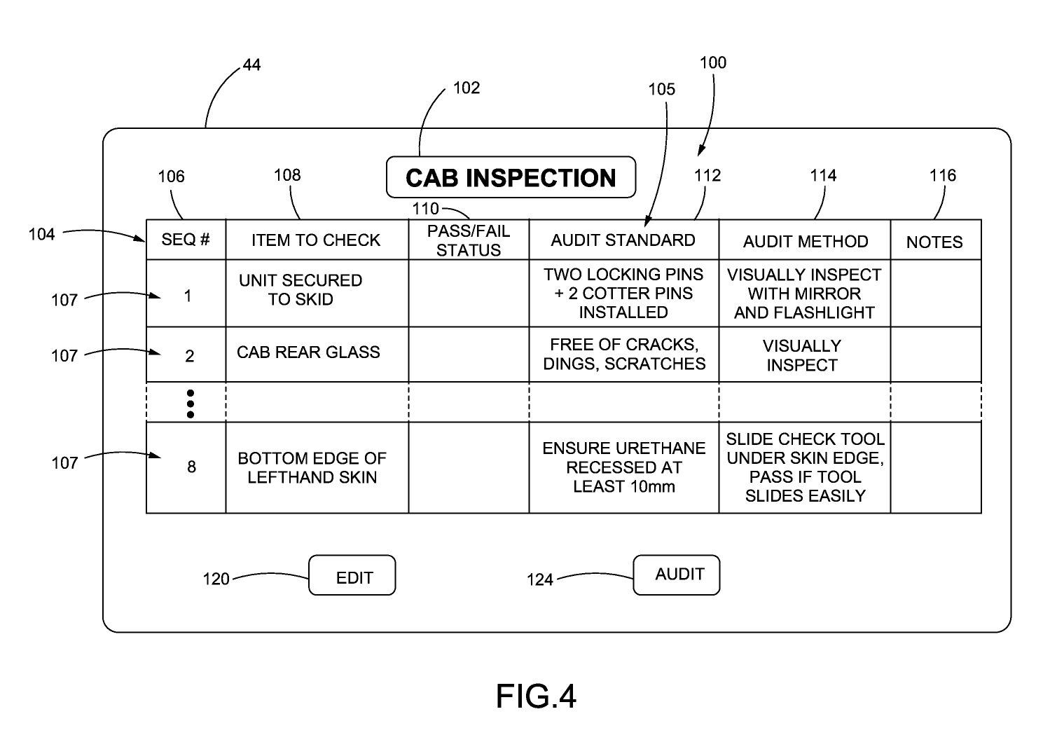

One or more checklists stored in the checklist database 22 may be accessed using the device 44, such as through a checklist access interface 100 which may be displayed on the display screen 50 of the device 44 and is schematically illustrated in FIG. 4. The checklist access interface 100 may include a part identifier region 102 describing the part, sub-assembly, or assembly subject to quality control review. The part identifier may include text, a part number, or other information that identifies the part to be inspected.

The checklist access interface 100 further may include a quality control checklist region 104 in which is displayed an active checklist 105 retrieved from the checklist database 22. The checklist 105 includes a plurality of inspection items 107 arranged in an initial sequence. In the illustrated embodiment, the checklist 105 is arranged so that each inspection item 107 extends across a row formed in the quality control checklist region 104. The fields of the inspection items 107 are arranged in columns, as described in greater detail below.

More specifically, the quality control checklist region 104 may include a sequence identifier column 106, in which the steps in the quality control checklist may be identified by number. Additionally, the quality control checklist region 104 includes a component identifier column 108. The component identifier column 108 may identify by name or part number the part, sub-assembly, or assembly to be inspected at a particular step in the quality control checklist.

The component identifier column 108 may include text, photographs, video, audio, or other modes of information that may assist the user to locate the part to be inspected. As shown in FIG. 4, for example, exemplary component identifiers may be “Unit Secured to Skid,” “Cab Rear Glass,” or “Bottom Edge of Lefthand Skin,” however other component identifiers for identifying the same or different parts may be used. The quality control checklist region 104 also may include an inspection status identifier column 110, which may identify an inspection status of the part. In the present disclosure, the inspection status may be one of “PASS” or “FAIL,” however other status identifiers may be used.

The quality control checklist region 104 further may include an audit standard column 112. The audit standard column 112 may identify the desired condition of the inspection item, thereby communicating the standard by which the part will be deemed to pass or fail a particular step in the quality control checklist. For example, as shown in FIG. 4, the audit standard may be “Two Locking Pins and Two Cotter Pins Installed,” “Free of Cracks, Dings, Scratches,” or “Ensure Urethane Recessed at Least 10 mm,” however other audit standards associated with the same or different parts may be used. The audit standard column 112 may include text, photographs, video, audio, or other modes of information that may assist the user in understanding the desired condition of the inspection item.

An audit method column 114 may be provided in the quality control checklist region 104 for explaining how to check for compliance with the associated audit standard 112. Accordingly, the audit method column 114 may identify an inspection process, inspection tools, or other information that may help the user carry out the desired inspection step. The audit method column 114 may include text, photographs, video, audio, or other modes of information that may communicate the inspection method to the user. For example, as shown in FIG. 4, the audit method column may include text such as “Visually Inspect with Mirror and Flashlight,” “Visually Inspect,” or “Slide Check Tool under Skin Edge, Pass if Tool Slides Easily.”

Still further, the quality control checklist region 104 may include a notes column 116 in which a user may provide annotations, as will be described in greater detail below.

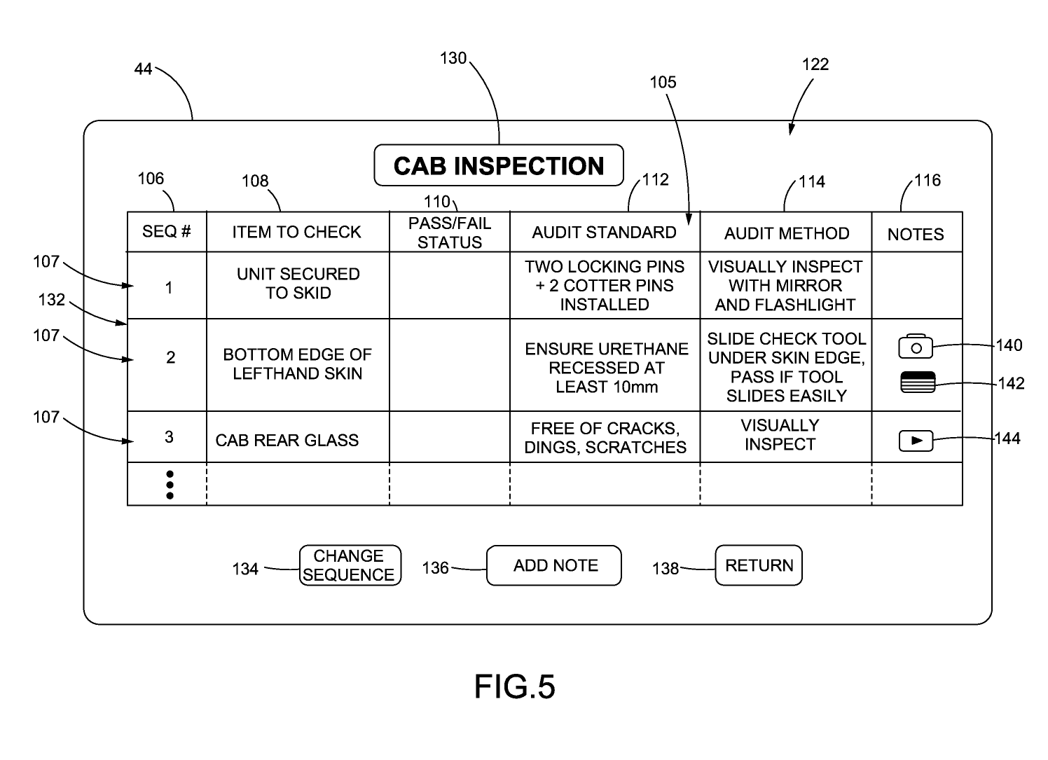

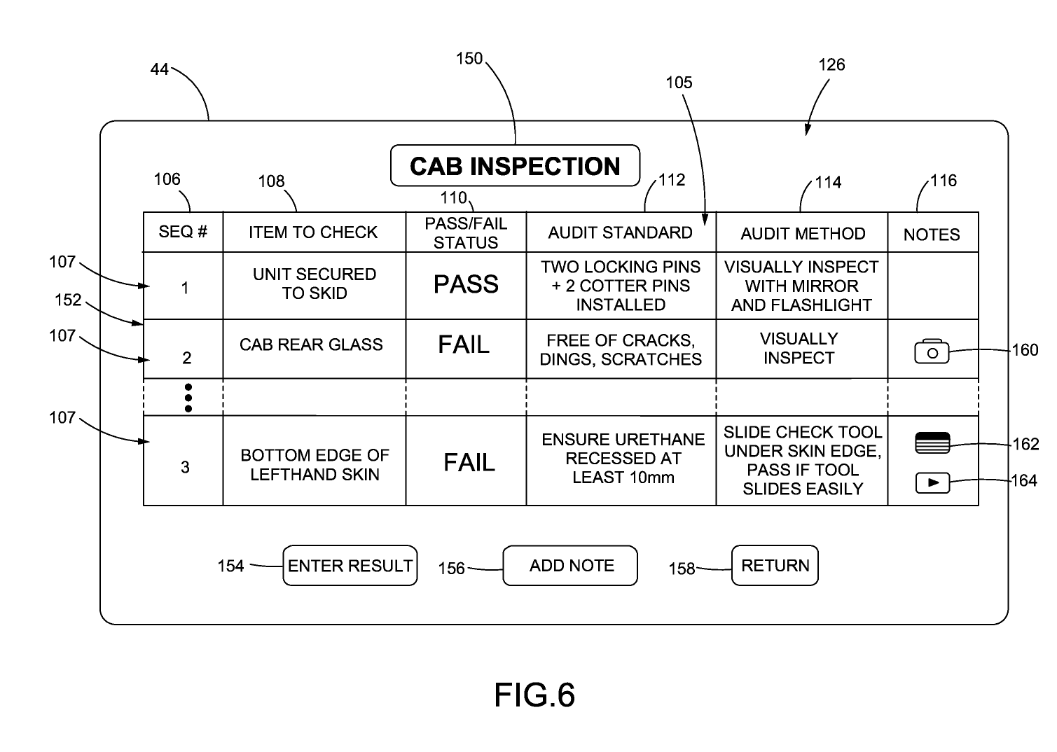

In addition to the quality control checklist region 104, the checklist access interface 100 may include inputs. For example, the checklist access interface 100 may include an editing input 120 for accessing a checklist editing interface 122 (FIG. 5) and an auditing input 124 for accessing an auditing interface 126 (FIG. 6), as described in greater detail below.

More specifically, the checklist editing interface 122 permits a user to modify an existing checklist to obtain an updated checklist, which may then be stored in the checklist database 22. As shown in FIG. 5, the checklist editing interface 122 may include a part identifier region 130 and a quality control checklist region 132 that are similar to those provided in the checklist access interface 100 noted above. In addition, the checklist editing interface 122 includes inputs for performing certain types of editing functions, such as a change sequence input 134 and an annotation input 136. Still further, the checklist editing interface 122 may include a return input 138 for exiting the checklist editing interface 122.

The change sequence input 134, permits a user to modify the sequence in which the steps of the quality control checklist are presented. For example, the step of inspecting the bottom edge of lefthand skin, which was identified by sequence number eight in FIG. 4, has been changed to sequence number two in FIG. 5, with the cab rear glass inspection item 107 being moved to sequence number three. Such a change in sequence may be desirable to improve convenience and efficiency of the quality control audit process.

The annotation input 136 permits a user to add user notes to an existing checklist. The user notes may be in the form of text, photos, video, or audio information that explains or otherwise illustrates the item to be inspected, the standards by which the part will be inspected, and/or the method for carrying out the inspection item. User notes may be added to the component identifier column 108, audit standard column 112, and/or audit method column 114 as noted above, or alternatively may be added to the notes column 116. The user notes may be inserted directly into the quality control checklist region 132.

Alternatively, an icon may be inserted into the quality control checklist region 132 that provides an input for accessing the associated note. The icon may be configured to indicate the medium (i.e., text, photograph, video, etc.) in which the note is provided. As shown in FIG. 5, for example, a photo icon 140, a text note icon 142, and a video icon 144 have been added to the notes column 116 of the quality control checklist region 132. A user may select the desired icon to access the user note.

The auditing interface 126 permits a user to enter the results of each inspection item as well as add notes explaining how those results were determined. As shown in FIG. 6, the checklist auditing interface 126 may include a part identifier region 150 and a quality control checklist region 152 that are similar to those provided in the checklist access interface 100 noted above. In addition, the checklist auditing interface 126 includes inputs for performing certain types of auditing functions, such as audit result entry input 154 and an audit annotation input 156. Still further, the checklist auditing interface 126 may include a return input 158 for exiting the checklist auditing interface 126.

The audit result entry input 154 permits a user to complete the status of a particular inspection item once it has been performed. As shown in FIG. 6, each of the inspection items is shown to include a status of either “PASS” or “FAIL.” In addition to the text, the status of the inspection item may be indicated by a background color, such as green for “PASS” and red for “FAIL.” Once the checklist has been completed with the audit results, it may be saved to the checklist database 22.

The audit annotation input 156 permits a user to add audit notes to an existing checklist that explain how the audit result was determined. If the status of an inspection item is “FAIL,” for example, the audit annotation input 156 may be used to associate documentation with the particular inspection item on the checklist. For example, photograph, text, video, or audio information may be added to the quality control checklist region 152. The audit notes may be inserted directly into the quality control checklist region 152, such as in the inspection status identifier column 110.

Alternatively, an icon may be inserted into the quality control checklist region 132 that provides an input for accessing the associated audit note. The icon may be configured to indicate the medium (i.e., text, photograph, video, etc.) in which the audit note is provided. As shown in FIG. 6, for example, a photo icon 160, a text note icon 162, and a video icon 164 have been added to the notes column 116 of the quality control checklist region 152. A user may select the desired icon to access the audit note.

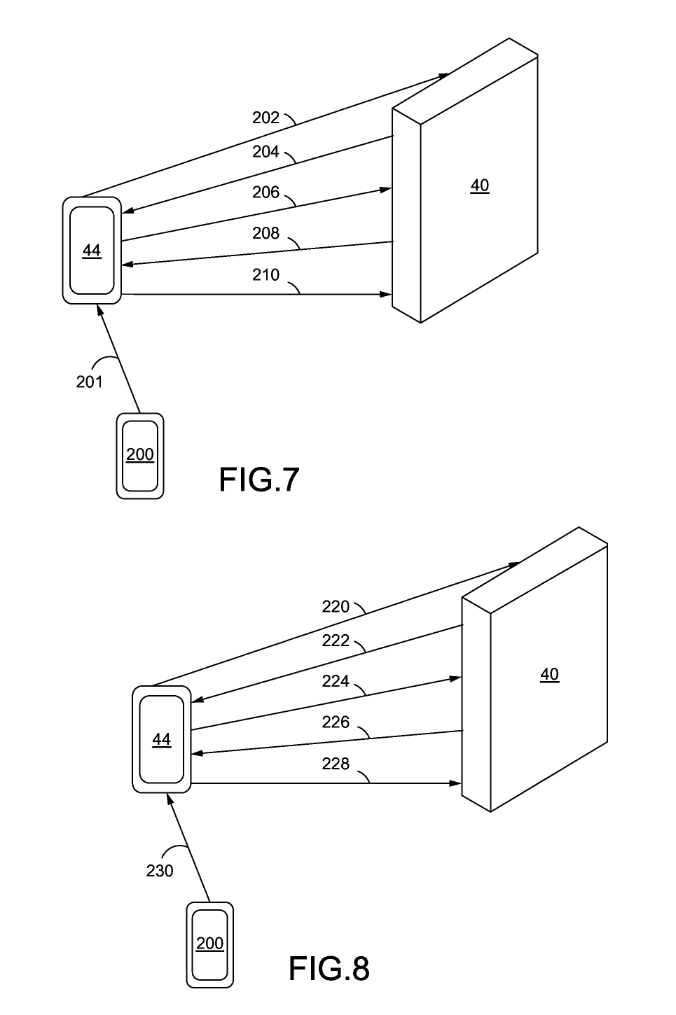

FIG. 7 schematically illustrates a sequence of transactions for editing a quality control checklist stored in the checklist database 22 to obtain an updated checklist. In the illustrated embodiment, the transactions are executed between the server 40 that stores or is otherwise coupled to the checklist database 22, the device 44, and optionally a second device 200. In a first transaction 202, user login information is transmitted from the device 44 to the server 40. After verifying the login information, the server 40 transmits the selected checklist to the device 44 in a second transaction 204. In a third transaction 206, the server 40 receives a request to access the checklist editing interface 122, such as by a user selecting the change sequence input 134 or the annotation input 136. The server 40 then enables the checklist editing interface 122 in a fourth transaction 208, during which the user may edit a sequence of the checklist and/or add notes to the checklist. Once the user is finished making edits, the server 40 may receive from the device 44 and store the updated checklist in a fifth transaction 210.

Optionally, in an alternative embodiment, an initial transaction 201 may involve a request transmitted by the second device 200 (FIG. 7) to the device 44 to initiate editing of the quality control checklist. For example, the second device 200 may be associated with the recipient 30 of the finished part, while the device 44 is associated with the supplier 28. The recipient 30, therefore, may initiate a request to edit the quality control checklist, such as by forwarding proposed checklist changes to the supplier 28. The supplier 28, in turn, may review the proposed checklist changes and if approved, formally edit the quality control checklist such as by executing the sequence of transactions noted above.

FIG. 8 schematically illustrates a sequence of transactions for adding an audit note to a quality control checklist stored in the checklist database. In a first transaction 220 of the exemplary embodiment, user login information is transmitted from the device 44 to the server 40. After verifying the login information, the server 40 transmits the selected checklist to the device in a second transaction 222. The server 40 receives from the device 44 a request to access the checklist auditing interface 126, such as by a user selecting the audit annotation input 156, in a third transaction 224. In a fourth transaction 226, the server 40 enables the checklist auditing interface 126, during which the user may select the audit result entry input 154 to enter a status of an inspection item and/or the audit annotation input 156 to add an audit note to the checklist.

Once the user is finished entering audit results and/or adding audit notes, the server 40 may receive and store the completed checklist in a fifth transaction 228. Optionally, in an additional transaction 230, the device 44 may transmit the completed checklist to the second device 200, so that both the supplier 28 and the recipient 30 have the same completed checklist.

### INDUSTRIAL APPLICABILITY

Embodiments of dynamic quality control checklists and methods are provided above that may be quickly and easily used and modified. By permitting modifications to be made to the checklist as well as adding audit notes, discrepancies in quality control standards used by a supplier and a recipient of a finished part may be reduced. Additionally, the quality control checklists may be adapted to promote convenience and efficiency during the quality control review. Still further, the ability to add annotations to the checklists may help facilitate identification of the part to inspect, clarify the standard by which the part will be judged, explain the method or process for inspecting the part, and document why a part was assigned a particular status.

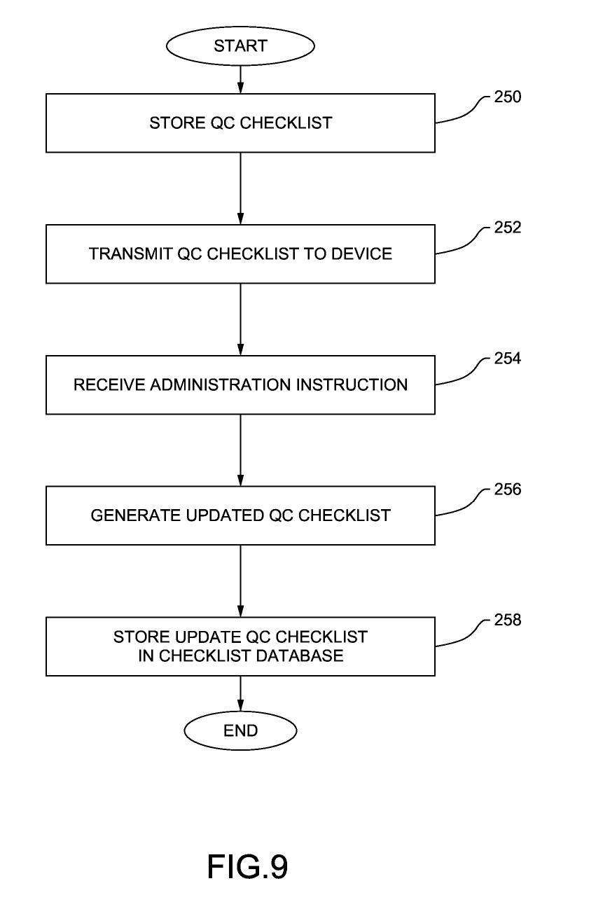

FIG. 9 illustrates one example method of controlling quality of a finished part by permitting editing of a quality control checklist. At stage 250, a quality control checklist is stored in the checklist database 22. The quality control checklist may include a plurality of inspection items ordered in an initial sequence, which each inspection item identifying a specification characteristic associated with the finished part. The specification characteristic may include information identifying the part, the standard by which the part will be inspected, and the method or process for inspecting the part. At stage 252, the quality control checklist is transmitted to a portable electronic device. At stage 254, the server 40 may receive from the portable electronic device 44 an administration instruction for modifying at least one inspection item of the plurality of inspection items.

As noted above, the administration instruction may be initiated by the user selecting the checklist editing interface 122 and further selecting the change sequence input 134 and/or the annotation input 136. Based on the administration instruction, the server 40 may generate an updated quality control checklist as shown at stage 256. At stage 258, the updated quality control checklist is stored in the checklist database 22.

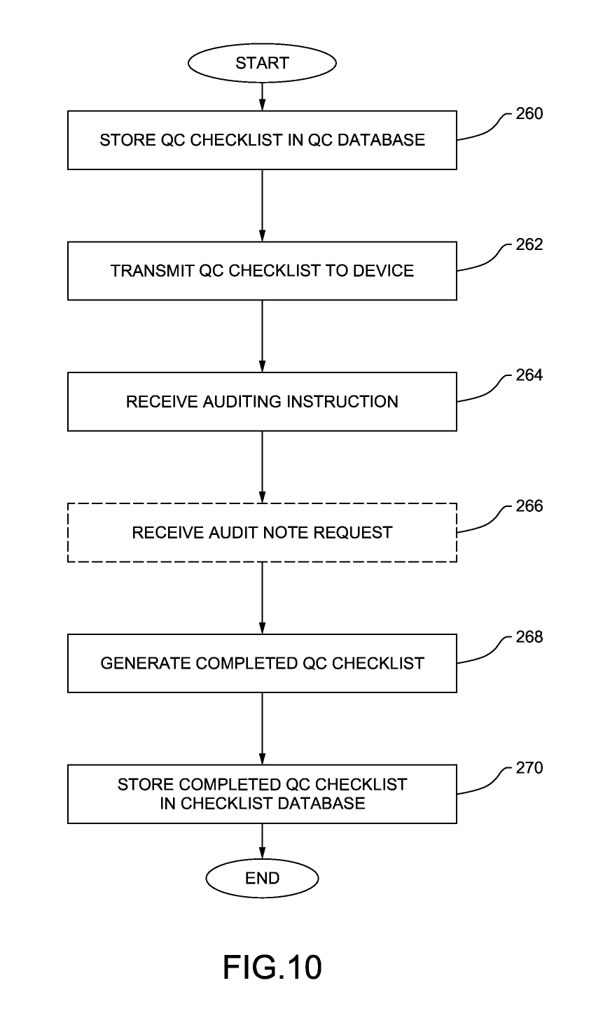

FIG. 10 illustrates one example method of controlling quality of a finished part by permitting annotations to be added to a checklist during auditing. At stage 260, a quality control checklist is stored in the checklist database 22. The quality control checklist may include a plurality of inspection items, with each inspection item identifying a specification characteristic associated with the finished part. The specification characteristic may include information identifying the part, the standard by which the part will be inspected, and the method or process for inspecting the part.

At stage 262, the quality control checklist is transmitted from the server 40 to the portable electronic device 44. At stage 264, the server 40 may receive from the portable electronic device 44 an auditing result indicating an inspection status associated with at least one inspection item of the plurality of inspection items. The auditing result may be a status of a completed inspection item, such as a “PASS” or “FAIL” grade. Optionally, at stage 266, the server 40 may also receive from the portable electronic device 44 a request to add an audit note to the checklist, such as by the user selecting the audit annotation input 156. At stage 268, the server may generate a completed quality control checklist based on the auditing result that includes the inspection status and/or audit note, and the server 40 may store the completed quality control checklist in the checklist database 22 at stage 270. Additionally or alternatively, the identity of the auditor may be logged and associated with the completed quality control checklist to facilitate review of completed inspections.

It will be appreciated that the foregoing description provides examples of the disclosed systems and techniques. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method of controlling quality of a finished part using a quality control server associated with a checklist database, the method comprising:
storing a quality control checklist in the checklist database, the quality control checklist including a plurality of inspection items, each inspection item identifying a specification characteristic associated with the finished part;
transmitting the quality control checklist to a portable electronic device;
receiving, from the portable electronic device, an auditing result indicating an inspection status associated with at least one inspection item of the plurality of inspection items;
generating a completed quality control checklist based on the auditing result, the completed quality control checklist including the inspection status associated with the at least one inspection item; and
storing the completed quality control checklist in the checklist database.

2. The method of claim 1, in which the inspection status comprises a passing status or a failing status.

3. The method of claim 2, further comprising receiving, from the portable electronic device, an inspection note associated with the auditing result.

4. The method of claim 3, in which the inspection note is provided in at least one of a text format, a photo format, a video format, or an audio format.

5. The method of claim 3, in which the completed quality control checklist includes an inspection status identifier column, and in which the inspection note is stored in the inspection status identifier column.

6. The method of claim 3, in which the completed quality control checklist includes a notes column, and in which the inspection note is stored in the notes column.

7. The method of claim 1, further comprising transmitting the completed quality control checklist to a second portable electronic device.

8. A system of controlling quality of a finished part comprising:
a checklist database; and
a quality control server linked to the checklist database, the quality control server including a processor configured via computer-executable instructions to store a quality control checklist in the checklist database, the quality control checklist including a plurality of inspection items, each inspection item identifying a specification characteristic associated with the finished part, transmit the quality control checklist to a portable electronic device, receive, from the portable electronic device, an auditing result indicating an inspection status associated with at least one inspection item of the plurality of inspection items, generate a completed quality control checklist based on the auditing result, the completed quality control checklist including the inspection status associated with the at least one inspection item, and store the completed quality control checklist in the checklist database.

9. The system of claim 8, in which the inspection status comprises a passing status or a failing status.

10. The system of claim 9, further comprising receiving, from the portable electronic device, an inspection note associated with the auditing result.

11. The system of claim 10, in which the inspection note is provided in at least one of a text format, a photo format, a video format, or an audio format.

12. The system of claim 10, in which the completed quality control checklist includes an inspection status identifier column, and in which the inspection note is stored in the inspection status identifier column.

13. The system of claim 10, in which the completed quality control checklist includes a notes column, and in which the inspection note is stored in the notes column.

14. The system of claim 8, further comprising transmitting the completed quality control checklist to a second portable electronic device.

15. A method of controlling quality of a finished part using a quality control server associated with a checklist database, the method comprising:
writing a quality control checklist to the checklist database, the quality control checklist including a plurality of inspection items ordered in an initial sequence, each inspection item identifying a specification characteristic associated with the finished part;
transmitting the quality control checklist to a portable electronic device;
receiving, from the portable electronic device, an administration instruction for modifying at least one inspection item of the plurality of inspection items;
generating an updated quality control checklist based on the administration instruction for modifying the at least one inspection item; and
storing the updated quality control checklist in the checklist database.

16. The method of claim 15, in which the administration instruction includes a reordered sequence of the plurality of inspection items, and the updated quality control checklist includes the plurality of inspection items ordered in the reordered sequence.

17. The method of claim 15, in which the administration instruction includes an annotation associated with at least one of the plurality of inspection items, and in which the annotation is stored with the updated quality control checklist in the checklist database.

18. The method of claim 17, in which the annotation is provided in at least one of a text format, a photo format, a video format, or an audio format.

19. The method of claim 15, in which the administration instruction includes a revised inspection item, and in which the updated quality control checklist includes the revised inspection item.

20. The method of claim 15, in which the administration instruction includes a request to delete a selected one of the plurality of inspection items, and in which the updated quality control checklist is modified to remove the selected one of the plurality of inspection items from the quality control checklist.
